(19) United States
(12) Patent Application Publication
(10) Pub. No.: US 2024/0236264 A1
(43) Pub. Date: Jul. 11, 2024

(54) ELECTRONIC DEVICE FOR PLAYING VIDEO AND OPERATING METHOD OF THE SAME

(71) Applicant: SAMSUNG ELECTRONICS CO., LTD., SUWON-SI (KR)

(72) Inventor: TAEHONG KIM, SUWON-SI (KR)

(21) Appl. No.: 18/403,842

(22) Filed: Jan. 4, 2024

(30) Foreign Application Priority Data
Jan. 5, 2023 (KR) 10-2023-0001914

(51) Int. Cl. H04N 7/035; H04N 7/01

(52) U.S. Cl. CPC H04N 7/0357; H04N 7/0102

(57) ABSTRACT

An electronic device for processing and playing a video transmitted from an input device is provided. The electronic device includes video processors and a processor. The video processors are configured to perform processing operations based on a test video including frames received from the input device to generate a sampling video including the frames, where each of the frames include at least one pattern. The processor is configured to receive the sampling video, determine whether the sampling video is output normally or not and an output order of each of the plurality of frames on the sampling video, based on the at least one pattern, and determine whether an error occurs in at least one of the input device and the plurality of video processors, based on the output order of each of the plurality of frames and whether the sampling video is output normally or not.

### CROSS-REFERENCE TO RELATED APPLICATION

This U.S. patent application is based on and claims priority under 35 U.S.C. § 119 to Korean Patent Application No. 10-2023-0001914, filed on Jan. 5, 2023, in the Korean Intellectual Property Office, the disclosure of which is incorporated by reference in its entirety herein.

### 1. TECHNICAL FIELD

The inventive concept relates to an electronic device, and more particularly, to an electronic device for processing and playing a video and an operating method of the electronic device.

### 2. DISCUSSION OF RELATED ART

A video may be streamed to an electronic device for display of a video image using various video services in a network environment. The video may be transmitted through, for example, mobile industry processor interface (MIPI), high definition multimedia interface (HDMI), display port (DP), peripheral component interconnect express (PCIe), or the like.

When a video is received from an input device or the electronic device processes and plays the video, image disconnection such as judder or stuttering may occur. When image disconnection is a problem of the input device, it may be necessary to correct an error of the input device. When image disconnection is a problem of the electronic device, it may be necessary to correct an error of the electronic device.

Therefore, in a process of receiving and playing a video, it may be necessary to determine a portion where an error occurs.

### SUMMARY

At least one embodiment of the inventive concept determines whether an error occurs in the input device or the electronic device by using a test video including at least one pattern.

According to an aspect of the inventive concept, there is provided an electronic device for processing and playing a video transmitted from an input device. The electronic device includes a plurality of video processors and a processor. The video processors are configured to perform processing operations on a test video including a plurality of frames received from the input device to generate a sampling video including the plurality of frames, where each includes at least one pattern. The processor is configured to receive the sampling video, determine whether the sampling video is output normally or not and an output order of each of the plurality of frames on the sampling video, based on the at least one pattern, and determine whether an error has occurred in at least one of the input device and the plurality of video processors, based on the output order of each of the plurality of frames and whether the sampling video is output normally or not.

According to an aspect of the inventive concept, there is provided an electronic device for processing and playing a video transmitted from an input device. The electronic device includes an input module configured to receive at least one test video from the input device, where each test video includes a plurality of frames including a first pattern and a second pattern. The processor is configured to determine an output order of each of the plurality of frames included in at least one sampling video generated from performing a processing operation on the at least one test video, based on the first pattern, determine whether the at least one sampling video is output normally or not, based on the second pattern, and determine whether an error has occurred in at least one of the input device and the electronic device, based on the output order and whether the at least one sampling video is output normally or not.

According to an aspect of the inventive concept, there is provided an operating method of an electronic device for processing and playing a video transmitted from an input device. The operating method includes: receiving at least one test video, each including a plurality of frames including at least one pattern, from the input device, generating a final sampling video obtained by performing a plurality of processing operations on the at least one test video, determining an output order of the final sampling video and whether the final sampling video is output normally, based on the at least one pattern, and determining whether an error has occurred in at least one of the input device and the electronic device, based on an output order of each of the plurality of frames of the final sampling video and whether the final sampling video is output normally or not.

According to an aspect of the inventive concept, there is provided an electronic device for processing and playing a video transmitted from an input device. The electronic device includes an input module, a processor, and a display device. The input module is configured to receive at least one test video from the input device, where each test video includes a plurality of frames including a first pattern and a second pattern. The processor is configured to check an output order of each of a plurality of frames included in at least one sampling video generated from performing a processing operation on the at least one test video, based on the first pattern, check whether the at least one sampling video is output normally, based on the second pattern, and determine whether an error occurs in at least one of the input device and the electronic device, based on the output order and whether the at least one sampling video is output normally. The display device is configured to display information indicating a location of the error, when the error occurs in at least one of the input device and the electronic device.

### BRIEF DESCRIPTION OF THE DRAWINGS

Embodiments of the inventive concept will be more clearly understood from the following detailed description taken in conjunction with the accompanying drawings in which:

FIG. 1 is a block diagram illustrating a video system according to an embodiment;

FIG. 2 is a diagram for describing a test video according to an embodiment;

FIG. 3 is a diagram for describing a first pattern and a second pattern according to an embodiment;

FIG. 4 is a diagram for describing a plurality of test videos according to an embodiment;

FIG. 5A is a diagram for describing an operating method of an electronic device, according to an embodiment;

FIG. 5B is a diagram for describing an operating method of a processor, according to an embodiment;

FIG. 6 is a diagram for describing an operating method of an electronic device, according to an embodiment;

FIG. 7A is a diagram for describing a case where an output order error does not occur, according to an embodiment;

FIG. 7B is a diagram for describing a case where an output order error occurs, according to an embodiment;

FIG. 8A is a diagram for describing a second pattern according to an embodiment;

FIG. 8B is a diagram for describing a second pattern according to an embodiment;

FIG. 9 is a diagram for describing a case where a test video has rotated, according to an embodiment; and

FIG. 10 is a flowchart for describing an operating method of an electronic device, according to an embodiment.

### DETAILED DESCRIPTION OF THE EMBODIMENTS

Hereinafter, embodiments of the inventive concept will be described in detail with reference to the accompanying drawings.

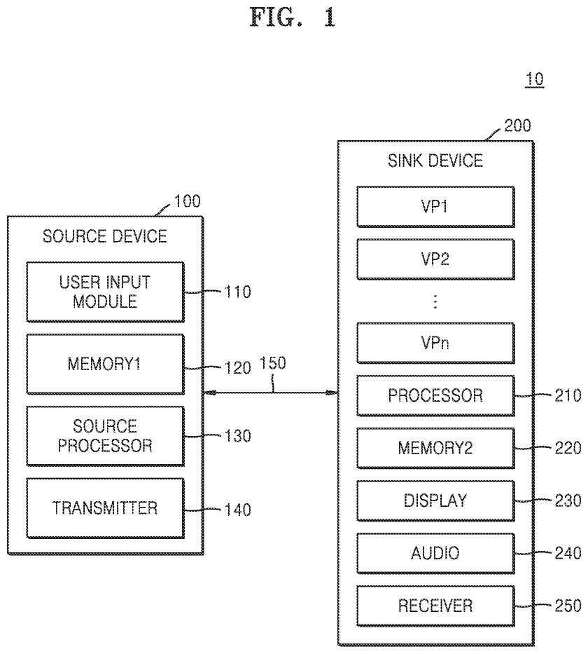

FIG. 1 is a block diagram illustrating a video system 10 according to an embodiment.

Referring to FIG. 1, the video system 10 may include a source device 100 and a sink device 200. According to an embodiment, the video system 10 may further include general-use elements other than the elements illustrated in FIG. 1.

The source device 100 may be an electronic device which autonomously generates a content video or is provided with the content video. The content video may include video frames, and moreover, may be generated as content data having a data stream form and may be transmitted to the sink device 200. The source device 100 may include an input device. The source device 100, for example, may be implemented as various types such as optical media players such as digital video disk or Blu-ray, ultra-high definition (UHD) players, set-top boxes, televisions (TVs), computer bodies, mobile devices, home theaters, game machines, and content servers. The content data may include video data or audio data. Alternatively, the content data may include video data and audio data.

In an embodiment, the source device 100 may include a user input module 110, a first memory 120 (e.g., a memory device), a source processor 130, and a transmitter 140.

The user input module 110 may be a module which is provided to enable manipulation by a user. The user input module 110 may include various kinds of input interface-related circuits. For example, the user input module 110 may be implemented as various types such as a mechanical or electronic button of the source device 100 and a touch pad, a touch screen, and a remote controller detached from a body of the source device 100.

The first memory 120 may read stored data and may output the read data, based on control by the source processor 130. Alternatively, the first memory 120 may store data, based on control by the source processor 130. The first memory 120 may store content video. The first memory 120 may be implemented by a non-volatile memory, which stores data regardless of the supply of power, or a volatile memory which operates only when power is supplied thereto. The non-volatile memory may include flash memory and read only memory (ROM), and the flash memory may include, for example, NAND flash memory and NOR flash memory. The volatile memory may include, for example, dynamic random access memory (RAM) (DRAM) and static RAM (SRAM).

The source processor 130 may overall control the source device 100. The source processor 130 may control the first memory 120 so that the first memory 120 outputs the content video. The source processor 130 may output the content data in a format supported by the sink device 200. For example, the source processor 130 may convert the content video from a first format into a second other format supported by the sink device 200.

The transmitter 140 may transmit the content video to the sink device 200. The transmitter 140 may transfer the content video to a receiver 250 of the sink device 200. The transmitter 140 may transfer the content video to the receiver 250 through a communication channel 150.

The communication channel 150 may transmit the content video, output from the source device 100, to the receiver 250. The communication channel 150 may include an arbitrary wireless or wired communication medium such as a radio frequency (RF) spectrum, one or more physical transmission lines, or an arbitrary combination of wireless and wired mediums. The communication channel 150 may configure a local area network, a global area network, or a portion of a packet-based network such as a global network or the Internet. The communication channel 150 may represent a set of different communication mediums or arbitrary suitable communication mediums for transmitting the content video from the source device 100 to the sink device 200.

In an embodiment, the source device 100 transmits a test video to the sink device 200. The test video may be a video used to check for the occurrence of an error of the video system 10. The test video may include a plurality of frames. Each of the plurality of frames may include at least one pattern. The test video may be transmitted in the form of a data stream. The data stream may include pixel values of pixels configuring a test video frame. For example, the data stream may include pixel values of pixels of at least one pattern included in the test video frame.

The test video may be stored in the first memory 120. The source processor 130 may control the first memory 120 so that the first memory 120 outputs the test video. The transmitter 140 may transmit the test video to the sink device 200. In detail, the transmitter 140 may transfer the test video to the receiver 250 through the communication channel 150.

In an embodiment, each of a plurality of frames of the test video include a first pattern and a second pattern. The first pattern may indicate an output order of each of the plurality of frames. For example, when one test video includes three frames, the first frame may include a first pattern indicating the first frame is ordered first (e.g., has No.1 output order), the second frame of the three frames may include a first pattern indicating the second frame is ordered second (e.g., has No.2 output order), and the third frame may include a first pattern indicating the third frame is ordered third (e.g., has No.3 output order). However, the inventive concept is not limited thereto, and the number of frames may be varied. The second pattern may represent a plurality of colors. For example, the second pattern may be a pattern including a red color, a blue color, and a green color. However, the inventive concept is not limited thereto, and the second pattern may include various colors other than red, blue, and green. For example, the second pattern may include colors and locations of pixels within a given pattern.

The source device 100 may transmit at least one of a plurality of test videos to the sink device 200. Each of the plurality of test videos may include a plurality of frames, and each of the plurality of frames may include at least one pattern. In an embodiment, the plurality of test videos may have different resolutions. For example, a resolution of a first test video may be 3840×2160. A resolution of a second test video may be 512×480. However, the inventive concept is not limited to listed examples, and the number of test videos may vary such as 100, 1,000, etc. and may have various different resolutions.

The plurality of test videos may be stored in the first memory 120. The source processor 130 may control the first memory 120 so that the first memory 120 outputs at least one of the plurality of test videos. The transmitter 140 may transmit at least one test video to the sink device 200. In detail, the transmitter 140 may transfer at least one test video to the receiver 250 through the communication channel 150.

In FIG. 1, it has been described that a test video is transmitted from the source device 100, but the inventive concept is not limited thereto. For example, a test video may be transmitted from an external storage device to the sink device 200. The external storage device may store a test video. In an embodiment, the external storage device receives a command and an address from the sink device 200 and accesses a memory cell selected from among memory cells of the external storage device using the address to retrieve the test video.

The external storage device may be, for example, a flash memory-based storage device. The flash memory may include, for example, NAND flash memory and NOR flash memory. The flash memory-based storage device may include, for example, a flash drive device based on a solid state drive (SSD) or a universal serial bus (USB). The external storage device may be implemented as a removable drive. The external storage device may be implemented as a record medium such as video compact disk (CD) and DVD.

The sink device 200 may be an electronic device which processes and plays a received video. The sink device 200 may process and play the test video transmitted from the source device 100. Here, the term “play” may denote that a processing operation is performed for displaying a video, an image based on processed video data is displayed, audio based on processed video data is output, or audio and an image based on processed video data and audio data are provided. The sink device 200 may be implemented as various types such as TVs, monitors, portable multimedia players, mobile phones, tablet computers, electronic picture frames, electronic bulletin boards, and electronic billboards.

In an embodiment, the sink device 200 includes video processors vp1, vp2, . . . , and vpn, a processor 210, a second memory 220 (e.g., a memory device), a display 230 (e.g., a display device), an audio device 240, and a receiver 250.

The video processors vp1, vp2, . . . , and vpn may perform processing operations for playing a video. The processing operation may denote that processing is performed to display a video on a display. For example, the processing operation may include a standardization operation, a decoding operation, a scaling operation, color correction, a frame rate changing operation, and an image quality processing operation. However, the inventive concept is not limited to the listed examples.

The video processors vp1, vp2, . . . , and vpn may perform processing operations for playing a content video. The video processors vp1, vp2, . . . , and vpn may perform processing operations for playing a test video. Each of the video processors vp1, vp2, . . . , and vpn may perform a processing operation corresponding thereto. Each of the video processors vp1, vp2, . . . , and vpn may perform a corresponding processing operation on a test video, and thus, may generate a sampling video. Each of a plurality of frames of the sampling video may include at least one pattern. For example, a first video processor vp1 may perform a standardization operation, and a second video processor vp2 may perform a scaling operation. The first video processor vp1 may receive a test video and may perform a standardization operation on the test video. The second video processor vp2 may perform a scaling operation on the test video. In an embodiment, the second video processor vp2 performs a scaling operation on a standardized test video.

For example, the first video processor vp1 may be an input module or function as an input module. The input module may receive a test video and may perform a standardization operation on the test video. A processing operation corresponding to the input module may be a standardization operation. In an embodiment, the standardization operation is an operation of changing a received video according to a characteristic of the sink device 200. The first video processor vp1 may output a first sampling video obtained by standardizing the test video. For example, the first video processor vp1 may perform the standardization operation on the test video to generate the first sampling video. The second video processor vp2 may be a scaler or perform a scaling operation. The scaler may perform the scaling operation on the test video. A processing operation corresponding to the scaler may be the scaling operation. In an embodiment, the scaling operation changes a size of a video, based on a size of the display device 230. In an embodiment, the second video processor vp2 receives the first sampling video from the first video processor vp1 and performs the scaling operation on the first sampling video to generate a second sampling video.

The processor 210 may determine whether an error has occurred in at least one of the source device 100 and the sink device 200, which are input devices. The processor 210 may receive a sampling video, where a processing operation corresponding to each of video processors has been performed on a test video, from at least one of the video processors vp1, vp2, . . . , and vpn. For example, the processor 210 may receive the sampling video from each of the video processors vp1, vp2, . . . , and vpn. The processor 210 may first receive the sampling video from the nth video processor vpn, and then, may receive a sampling video from the other video processors.

The processor 210 may determine, based on at least one pattern, an output order of each of a plurality of frames of the sampling video and whether the sampling video is output normally or not. In detail, the processor 210 may determine an output order and whether a normal or an abnormal output has occurred, based on at least one pattern included in each of the plurality of frames of the sampling video.

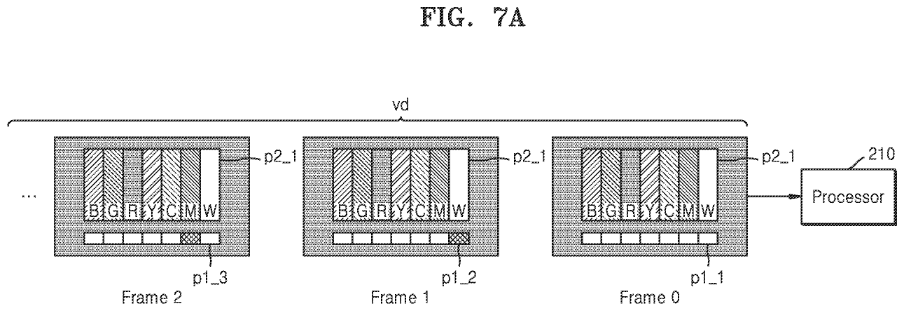

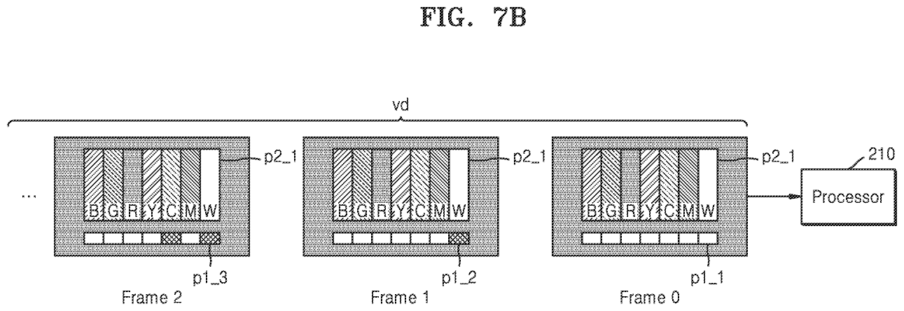

The processor 210 may determine the output order of each of the plurality of frames, based on a first pattern. The processor 210 may determine whether an output order error has occurred, based on the first pattern. The output order error will be described below with reference to FIGS. 7A and 7B.

The processor 210 may receive a sampling video from at least one of the video processors vp1, vp2, . . . , and vpn and may determine an output order of each sampling video. The processor 210 may determine an output order of a frame including the first frame, based on a first pattern included in each frame. For example, the processor 210 may determine that an output order of a first frame has a No.1 output order, based on a first pattern included in the first frame. The processor 210 may determine that an output order of a second frame has a No.2 output order, based on a first pattern included in the second frame. Thus, the processor 210 may determine an output order of each sampling video received and may determine whether an output order error has occurred.

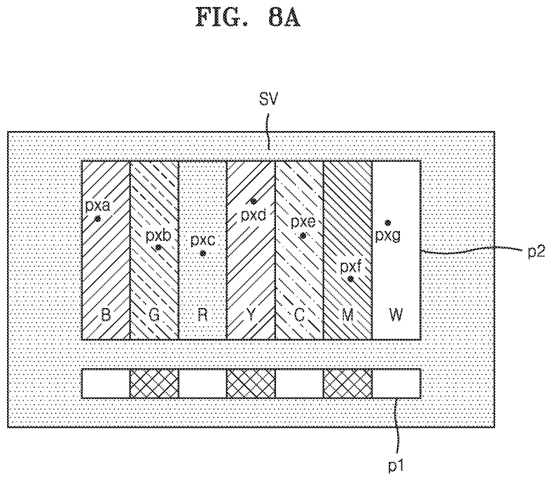

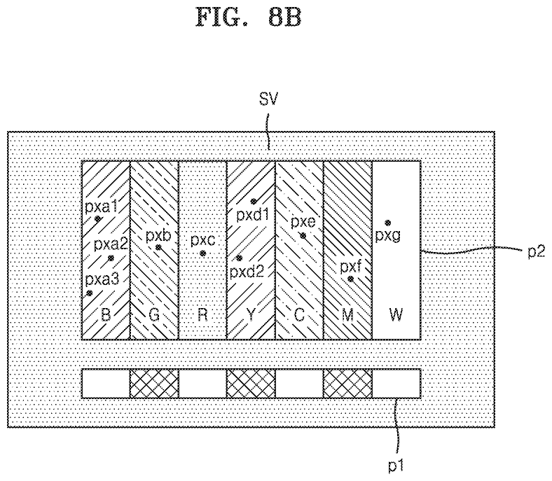

The processor 210 may determine whether a sampling video is output normally or not, based on a second pattern. The processor 210 may determine that a normal or an abnormal output has occurred, based on pixel values of pixels within the second pattern. The pixel values may represent RGB data. The processor 210 may compare a predetermined pixel value with the pixel values of pixels of the second pattern to determine whether a sampling video is output normally or not. The processor 210 may receive a sampling video from at least one of the video processors vp1, vp2, . . . , and vpn and may determine whether each sampling video is output normally or not. A normal output may denote a case where a color error does not occur because a processing operation is normally performed by a video processor. For example, the processor 210 may determine whether a first sampling video is output normally or not, based on a second pattern included in the first sampling video. A normal or abnormal output will be described with reference to FIG. 8A.

The processor 210 may determine whether an error has occurred in at least one of an input device and an electronic device, based on an output order of each of a plurality of frames of a sampling video and whether each of a plurality of frames of a sampling video is output normally or not. Here, the input device may denote the source device 100, and the electronic device may denote the sink device 200. The processor 210 may determine whether an error has occurred in at least one of the video processors vp1, vp2, . . . , and vpn and the input device (e.g., 100), based on an output order error and whether the sampling video is output normally or not. When an output order error of the sampling video output from at least one of the video processors vp1, vp2, . . . , and vpn does not occur and an output is a normal output, the processor 210 may determine that an error has not occurred in the input device (e.g., 100) and the sink device 200.

When at least one of an output order error of the first sampling video output from the first video processor vp1 and an abnormal output of the first sampling video occurs, the processor 210 may determine that an error has occurred in the input device (e.g., 100). For example, when the output order error of the first sampling video occurs, the processor 210 may determine that an error has occurred in the source device 100.

When at least one of an output order error and an abnormal output of a sampling video output from at least one of the video processors vp2, . . . , and vpn other than the first video processor vp1 occurs and an output order error and an abnormal output of the first sampling video do not occur, the processor 210 may determine that an error has occurred in the electronic device (e.g., 200). For example, when an output order error of a second sampling video output from the second video processor vp2 occurs and an output order error and an abnormal output of the first sampling video do not occur, the processor 210 may determine that an error has occurred in the sink device 200. For example, when an output order error of a second sampling video output from the second video processor vp2 occurs and an output order error and an abnormal output of the first sampling video do not occur, the processor 210 may determine than error has not occurred in the source device 100.

In an embodiment, the processor 210 may determine whether an error occurs in at least one of the video processors vp2, . . . , and vpn and the input device, based on an output order of each of a plurality of frames and whether a sampling video is output normally or not. For example, when an output order error of the second sampling video output from the second video processor vp2 occurs and an output order error and an abnormal output of the first sampling video do not occur, the processor 210 may determine that an error has occurred in the second video processor vp2.

The processor 210 may include one or more of a central processing unit (CPU), a graphics processor unit (GPU), a micro controller unit (MCU), a micro processing unit (MPU), an application processor (AP), and an ARM processor, or may be defined as a corresponding term. Also, the processor 210 may be implemented as large scale integration (LSI) or system on chip (SoC) embedded in a processing algorithm, or may be implemented as a field programmable gate array (FPGA).

The second memory 220 may store pixel values of pixels of a test video. In detail, the second memory 220 may store a predetermined pixel value for the processor 210 to determine an output order error of a plurality of frames of a sampling video and whether the plurality of frames of a sampling video is output normally or not. The second memory 220 may be implemented as a non-volatile memory, which stores data regardless of the supply of power, or a volatile memory which operates only when power is supplied thereto. The non-volatile memory may include flash memory and ROM, and the flash memory may include, for example, NAND flash memory and NOR flash memory. The volatile memory may include, for example, DRAM and SRAM.

The display device 230 may display an image, based on a content video on which a processing operation has been performed by the video processors vp1, vp2, . . . , and vpn. According to an embodiment, the display device 230 may display an image, based on a test video on which a processing operation has been performed by the video processors vp1, vp2, . . . , and vpn. The sink device 200 may display output data to a user through the display device 230. The display device 230 may denote a display panel. The display panel may be a display unit which displays a real image and may be one of a plurality of display devices, which receive an electrically transferred image signal to display a two-dimensional (2D) image, such as a thin film transistor-liquid crystal display (TFT-LCD), an organic light emitting diode (OLED) display, a field emission display, and a plasma display panel (PDP). The display panel may be implemented as other kinds of flat display or flexible display panels. In an embodiment, the display device 230 may display a 8K-class image, but is not limited thereto.

In an embodiment, when an error occurs in at least one of the input device and the electronic device, the display device 230 may display a notification indicating that the error has occurred. When an error occurs in at least one of the input device and the electronic device, the display device 230 may display a notification indicating the device where the error has occurred. In detail, when an error occurs in at least one of the source device 100 and the sink device 200, the processor 210 may control the display device 230 to display a notification indicating that the error has occurred and a location or identity of the entity (e.g., 100 or 200) where the error occurred.

When a first sampling video where a test video is standardized is received and at least one of an output order error of the first sampling video and an abnormal output of the first sampling video occurs, the processor 210 may determine that an error has occurred in the input device. For example, the processor 210 may determine that an error has occurred in the source device 100. When an error occurs in the source device 100, the processor 210 may control the display device 230 to display a notification indicating that an error has occurred in the source device 100. For example, the processor 210 may control the display device 230 to display information about an after-sales service center for the source device 100.

When at least one of an output order error and an abnormal output of a final sampling video, where processing operations have been performed on the first sampling video, occurs and at least one of an output order error and an abnormal output of the first sampling video does not occur, the processor 210 may determine that an error has occurred in the electronic device (e.g., 200). For example, the processor 210 may determine that an error has occurred in the sink device 200. When an error occurs in the sink device 200, the processor 210 may control the display device 230 to display a notification indicating that an error has occurred in the sink device 200. The processor 210 may control the display device 230 to display information about an after-sales service center for the sink device 200. When an error occurs in the sink device 200, the processor 210 may notify a user that an error of the sink device 200 has occurred in the after-sales service center for the sink device 200, through communication.

When an error occurs in at least one of the video processors vp1, vp2, . . . , and vpn and the input device (e.g., 100), the display device 230 may display a notification indicating that the error has occurred. For example, when an error occurs in the second video processor vp2, the processor 210 may perform a control so that the display device 230 displays a notification indicating that the error has occurred in the second video processor vp2.

The audio device 240 may output an audio, based on audio data transmitted from the source device 100.

The receiver 250 may receive a content video from the source device 100 through the communication channel 150. The receiver 250 may receive a test video from the source device 100 through the communication channel 150.

The transmitter 140, the communication channel 150, and the receiver 250 may each be configured for communication based on an arbitrary wired or wireless communication system including one or more Ethernets, a phone, a cable, a power-line, and optical systems, and/or one or more code division multiple access (CDMA or CDMA2000) communication systems, frequency division multiple access (FDMA) system, orthogonal frequency division multiple (OFDM) access system, time division multiple access (TDMA) such as global mobile communication system (GSM), general packet radio service (GPRS) or enhanced data GSM environment (EDGE), terrestrial trunked radio (TETRA) mobile phone system, wide band code division multiple access (WCDMA) system, high speed data rate one-generation evolution data dedicated (1xEV-DO) or 1xEV-DO gold multicast system, IEEE 802.18 system, digital multimedia broadcasting (DMB) system, digital video broadcasting-handheld (DVB-H) system, or a wireless system including a different scheme for data communication between two or more devices.

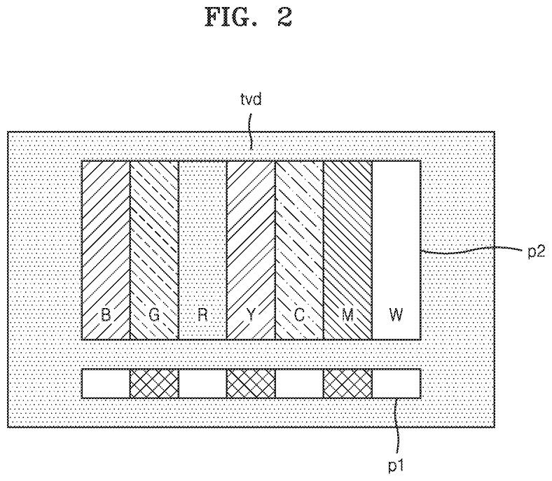

FIG. 2 is a diagram for describing a test video tvd according to an embodiment.

The test video tvd may be transferred from a source device to a sink device in the form of data stream. In FIG. 2, the test video tvd is illustrated as including one frame, but this is for convenience of description since the test video tvd may include a plurality of frames. A frame of the test video tvd may include at least one pattern.

In an embodiment, the test video tvd includes a first pattern p1 and a second pattern p2. The second pattern p2 is different from the first pattern p1. The first pattern p1 may indicate an output order of each frame included in the test video tvd. The first pattern p1 may represent an output order of each frame included in the test video tvd. In an embodiment, the first pattern p1 is a binary pattern. The first pattern p1 may be expressed as at least one of a first color (e.g., a black color) and a second color (e.g., a white color). For example, the first pattern p1 may include bands of pixels having the first color and the second color. However, the inventive concept is not limited thereto, and the first pattern p1 may be expressed in two colors contrasted to each other. The first pattern p1 may be transferred from the source device 100 to the sink device 200 in the form of a data stream. The first pattern p1 may be expressed as a plurality of bits. The number of bits expressed by the first pattern p1 may be determined based on the number of frames included in the test video tvd.

The second pattern p2 may represent a plurality of colors. For example, the second pattern p2 may include different color bands. The second pattern p2 may have a tetragonal shape including a plurality of colors. However, the inventive concept is not limited thereto, and the second pattern p2 may have a circular shape including a plurality of colors and may be expressed in various shapes. For example, the second pattern p2 may be a pattern including a red color, a blue color, and a green color. However, the inventive concept is not limited thereto since the second pattern p2 may include various colors. For example, the second pattern p2 may include seven colors such as a blue color, a green color, a red color, a yellow color, a cyan color, a magenta color, and a white color. The second pattern p2 may be transferred from the source device 100 to the sink device 200 in the form of data stream. The second pattern p2 may be expressed as RGB data.

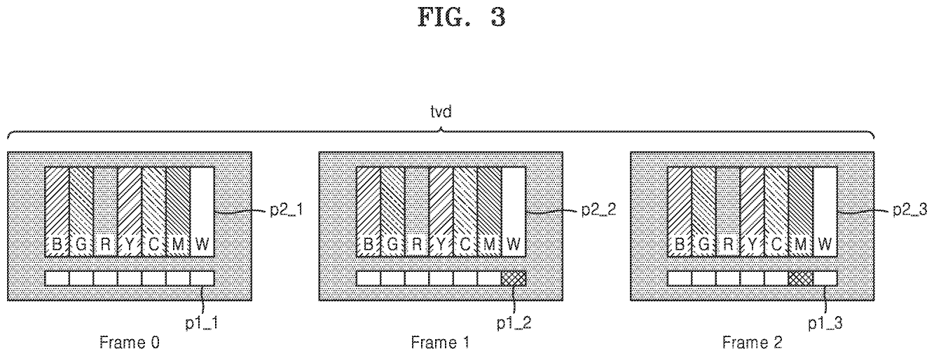

FIG. 3 is a diagram for describing a first pattern and a second pattern according to an embodiment. Descriptions which are the same as or similar to the above descriptions are omitted.

The test video tvd may include a plurality of frames. In FIG. 3, the test video tvd is illustrated as including three frames, but this is for convenience of description since the test video tvd may include three or more frames or may include two or less frames.

Each of the plurality of frames may include a first pattern and a second pattern. For example, a first frame (frame 0) may include a first pattern p1_1 and a second pattern p2_1. A second frame (frame 1) may include a first pattern p1_2 and a second pattern p2_2. A third frame (frame 2) may include a first pattern p1_3 and a second pattern p2_3.

The first pattern may indicate an output order of each of the plurality of frames. For example, an output order of the first frame (frame 0) may be No.1, and the first frame (frame 0) may include the first pattern p1_1 corresponding to the No.1 output order. The first pattern p1_1 may be a binary pattern representing the No.1 output order. An output order of the second frame (frame 1) may be No.2, and the second frame (frame 1) may include the first pattern p1_2 corresponding to the No.2 output order. The first pattern p1_2 may be a binary pattern representing No.2 output order. An output order of the third frame (frame 2) may be No.3, and the third frame (frame 2) may include the first pattern p1_3 corresponding to the No.3 output order. The first pattern p1_3 may be a binary pattern representing the No.3 output order. For example, pattern p1_1 could include seven bands of the first color at positions 1-7, pattern p1_2 could include six bands of the first color at positions 1-6 and a seventh band of a second color at position 7, and pattern p1_3 could include six bands of the first color at positions 1-5 and 7 a seventh band of the second color at position 6. The colors and the positions of the bands can be used to represent a bit pattern that indicates a unique order of a frame among several frames.

Each of the plurality of frames may include a second pattern. In an embodiment, each of a plurality of frames of the test video tvd include the same second pattern. For example, the second pattern p2_1, the second pattern p2_2, and the second pattern p2_3 may be equal to one another.

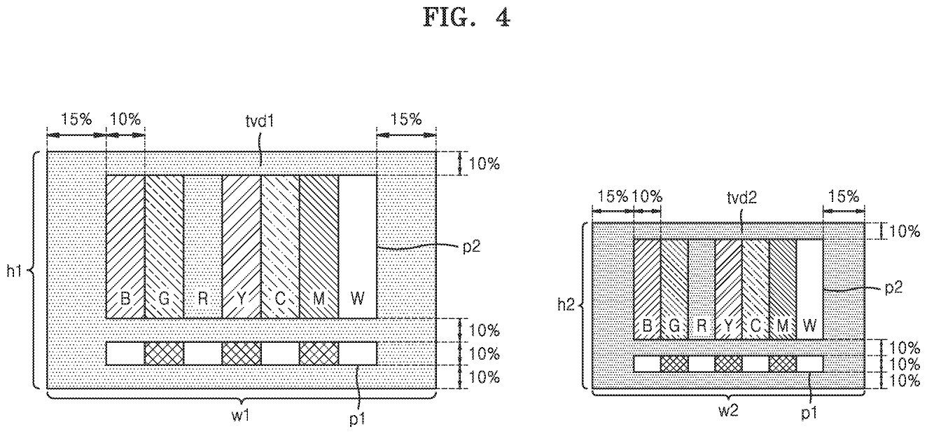

FIG. 4 is a diagram for describing a plurality of test videos according to an embodiment. Descriptions which are the same as or similar to the above descriptions are omitted.

At least one of a plurality of test videos may be transmitted from an input device (for example, the source device 100 of FIG. 1) to an electronic device (for example, the sink device 200 of FIG. 1). In FIG. 4, the plurality of test videos are illustrated as two, but are not limited thereto since the number of test videos may be various such as 100, 1,000, or the like. Also, in FIG. 4, each of the test videos is illustrated as including one frame, but this for convenience of description since the inventive concept is not limited thereto and each test video may include a plurality of frames.

In an embodiment, the plurality of test videos have different resolutions. A resolution of a first test video tvd1 and a resolution of a second test video tvd2 may differ from each other. For example, a resolution of the first test video tvd1 may be 3840×2160 and a resolution of the second test video tvd2 may be 1920×1080.

Based on a resolution, sizes of a first pattern p1 and a second pattern p2 may differ from each other. In an embodiment, sizes of a first pattern p1 and a second pattern p2 of the first test video tvd1 are greater than those of a first pattern p1 and a second pattern p2 of the second test video tvd2. Even when sizes of a first pattern p1 and a second pattern p2 differ, a ratio occupied by the first pattern p1 and a ratio occupied by the second pattern p2 in a frame may be equal to each other despite different resolutions. For example, in the first test video tvd1, the first pattern p1 may occupy 70% of a width w1 and 10% of a height h1. In the first test video tvd1, the second pattern p2 may occupy 70% of a width w1 and 60% of a height h1. In the second test video tvd2, the first pattern p1 may occupy 70% of a width w1 and 10% of a height h1. In the second test video tvd2, the second pattern p2 may occupy 70% of a width w1 and 60% of a height h1. However, a ratio occupied by the first pattern p1 and a ratio occupied by the second pattern p2 in FIG. 4 is merely an example and is not limited thereto.

The electronic device (e.g., 200) may receive at least one of a plurality of test videos having different resolutions and may determine whether an error has occurred in at least one of the input device (e.g., 100) and the electronic device (e.g., 200) for each resolution. For example, at least one of the plurality of test videos may be transmitted from the input device to the electronic device, based on a user input. The electronic device may receive a test video having a different resolution to determine whether an error occurs in the test video, and thus, may determine a device where an error has occurred for each resolution.

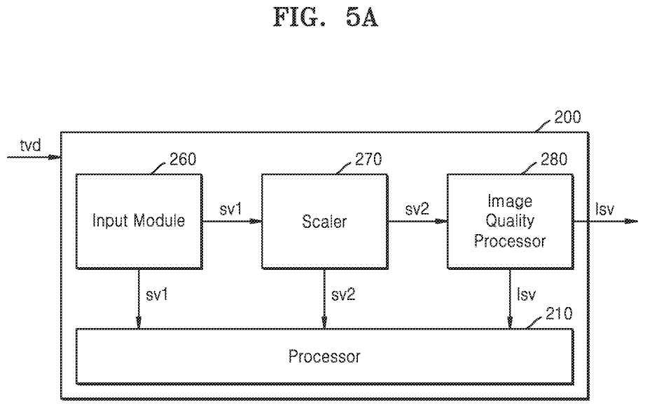

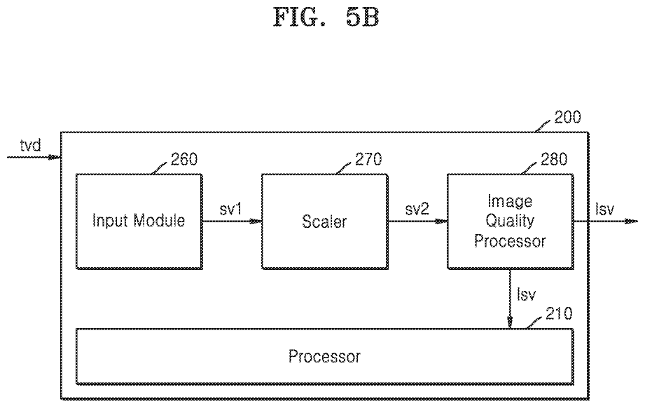

FIG. 5A is a diagram for describing an operating method of an electronic device 200, according to an embodiment. The electronic device 200 of FIG. 5A may correspond to the sink device 200 of FIG. 1, and thus, the processor 210 of FIG. 5A may correspond to the processor 210 of FIG. 1. Repeated descriptions are omitted.

Referring to FIG. 5A, the electronic device 200 may receive a test video tvd. The electronic device 200 may include a processor 210, an input module 260, a scaler 270, and an image quality processor 280. Each of the input module 260, the scaler 270, and the image quality processor 280 may be included in a video processor. FIG. 5A represents a case where three video processors are provided. However, the inventive concept is not limited thereto since the electronic device 300 may include a various number of video processors. For example, a single video processor may perform the functions of the input module 260, the scaler 270, and the image quality processor 280.

The input module 260 may receive a test video tvd. The input module 260 may correspond to the first video processor vp1 of FIG. 1. The input module 260 may perform a standardization operation on the test video tvd to output a first sampling video sv1. A processing operation corresponding to the input module 260 may be a standardization operation. The standardization operation may denote an operation of changing the received test video tvd according to a characteristic of the electronic device 200. In an embodiment, the input module 260 modifies space information and time information about the test video tvd so as to internally process the test video tvd in the electronic device 200.

The scaler 270 may receive the first sampling video sv1. The scaler 270 may correspond to the second video processor vp2 of FIG. 1. The scaler 270 may perform a scaling operation on the first sampling video sv1 to output a second sampling video sv2. A processing operation corresponding to the scaler 270 may be the scaling operation. The scaling operation may denote an operation of changing a size of a video according to a size of a display (for example, the display device 230 of FIG. 1). In detail, the scaler 270 may increase or reduce a size of the first sampling video sv1 in a horizontal direction, or may increase or reduce a size of the first sampling video sv1 in a vertical direction.

The image quality processor 280 may receive the second sampling video sv2. The image quality processor 280 may perform an image quality processing operation on the second sampling video sv2 to output a final sampling video lsv. The final sampling video lsv may denote a sampling video which is output from a video processor. The image quality processor 280 may perform a last processing operation among the video processors. Thus, the image quality processor 280 may be a final video processor. A processing operation corresponding to the image quality processor 280 may be an image quality processing operation. The image quality processing operation may be an operation of increasing the image quality of a video.

The processor 210 may receive a sampling video from at least one of the video processors. The processor 210 may receive a sampling video from at least one of the input module 260, the scaler 270, and the image quality processor 280. The processor 210 may determine whether an error has occurred in at least one of an input device and the video processors, based on an output order of a plurality of frames of the received sampling video and whether the plurality of frames of the received sampling video is output normally or not.

In an embodiment, the processor 210 receives the first sampling video sv1 from the input module 260 and determines an output order error of the first sampling video sv1 and whether the sampling video sv1 is output normally or not. When it is determined that an output order error occurs in a plurality of frames included in the first sampling video sv1, the processor 210 may determine that an error has occurred in the input device. When it is determined that an abnormal output of the first sampling video sv1 occurs, the processor 210 may determine that an error has occurred in the input device. When it is determined that an output order error and an abnormal output of the first sampling video sv1 has occurred, the processor 210 may determine that an error has occurred in the input device.

In an embodiment, the processor 210 receives a sampling video from each of the video processors and determines whether at least one of an output order error and an abnormal output of each sampling video has occurred. The processor 210 may receive the first sampling video sv1 from the input module 260 and may determine whether at least one of an output order error and an abnormal output of the first sampling video sv1 has occurred. The processor 210 may receive the second sampling video sv2 from the scaler 270 and may determine whether at least one of an output order error and an abnormal output of the second sampling video sv2 has occurred. The processor 210 may receive the final sampling video lsv from the image quality processor 280 and may determine whether at least one of an output order error and an abnormal output of the final sampling video lsv has occurred.

The processor 210 may determine whether an error occurs in a target video processor, based on whether an error has occurred in a video processor which performs a processing operation on a test video prior to the target video processor outputting a sampling video where at least one of an output order error and the abnormal output has occurred.

When at least one of an output order error and an abnormal output of the second sampling video sv2 occurs, the processor 210 may determine that an error has occurred in at least one of the input device and the electronic device 200. In detail, the processor 210 may determine that the error has occurred in at least one of the input device and the scaler 270. When at least one of an output order error and an abnormal output of the second sampling video sv2 occurs, the target video processor may be the scaler 270. The processor 210 may determine whether an error of the input device has occurred or not, based on whether an error of the input module 260 which performs a processing operation prior to the scaler 270 has occurred. The occurrence of an error of the input module 260 may denote that an error has occurred in the input device. The processor 210 may determine whether an error of the input device has occurred, based on whether an output order error and an abnormal output of the first sampling video sv1 have occurred. When an output order error and an abnormal output of the first sampling video sv1 do not occur but at least one of an output order error and an abnormal output of the second sampling video sv2 occurs, the processor 210 may determine that an error has occurred in the electronic device. In detail, the processor 210 may determine that an error has occurred in the scaler 270.

When at least one of an output order error and an abnormal output of the final sampling video lsv occurs, the processor 210 may determine that an error has occurred in at least one of the input device and the electronic device 200. In detail, the processor 210 may determine that an error has occurred in the image quality processor 280. When at least one of an output order error and an abnormal output of the final sampling video lsv occurs, the target video processor may be the image quality processor 280. The processor 210 may determine whether an error of the image quality processor 280 has occurred, based on whether an error has occurred in the scaler 270 which performs a processing operation prior to the image quality processor 280. When an output order error and an abnormal output of the second sampling video sv2 do not occur but at least one of an output order error and an abnormal output of the final sampling video lsv occurs, the processor 210 may determine that an error has occurred in the image quality processor 280.

FIG. 5B is a diagram for describing an operating method of a processor 210, according to an embodiment. Comparing with FIG. 5A, FIG. 5B may represent a case where the processor 210 first receives a final sampling video lsv from an image quality processor 280. Descriptions which are the same as or similar to the above descriptions are omitted.

The processor 210 may receive the final sampling video lsv from a final video processor. In FIG. 5B, the final video processor may be the image quality processor 280. The processor 210 may determine whether an error has occurred in at least one of an input device and video processors, based on an output order of each of a plurality of frames of the final sampling video lsv and whether the final sampling video lsv is output normally or not.

When an output order error of each of the plurality of frames of the final sampling video lsv and an abnormal output of the final sampling video lsv do not occur, the processor 210 may determine that an error does not occur in the input device and the video processors. The processor 210 may determine that an error does not occur in the input module 260, the scaler 270, and the image quality processor 280.

When at least one of an output order error and the abnormal output of the final sampling video lsv occurs, the processor 210 may determine whether an error has occurred in at least one of the input device and the video processors, based on whether an error has occurred in a video processor which performs a processing operation on a test video tvd prior to the target video processor. When at least one of the output order error and the abnormal output of the final sampling video lsv occurs, the processor 210 may determine whether an error has occurred in the image quality processor 280, based on whether an error of the scaler 270 has occurred. When an output order error and an abnormal output of the second sampling video sv2 do not occur, the processor 210 may determine that an error has occurred in the image quality processor 280.

When at least one of the output order error and the abnormal output of the final sampling video lsv occurs and at least one of the output order error and the abnormal output of the second sampling video sv2 occurs, the processor 210 may determine whether an error has occurred in at least one of the input device and the video processors, based on whether an error of the input device has occurred.

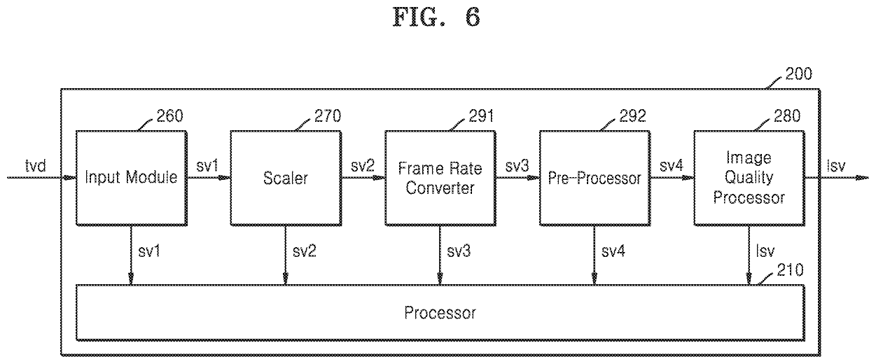

FIG. 6 is a diagram for describing an operating method of an electronic device 200, according to an embodiment. Comparing with FIGS. 5A and 5B, FIG. 6 may include five video processors. Descriptions which are the same as or similar to the above descriptions are omitted.

Referring to FIG. 6, the electronic device 200 may receive a test video tvd. The electronic device 200 may include a processor 210, an input module 260, a scaler 270, and an image quality processor 280. The electronic device 200 may further include a frame rate converter 291 (e.g., a logic circuit) and a pre-processor 292. Each of the input module 260, the scaler 270, the image quality processor 280, the frame rate converter 291 and the pre-processor 292 may include a video processor. FIG. 6 represents a case where five video processors are provided. However, the inventive concept is not limited thereto since the electronic device 300 may include various numbers of video processors.

The frame rate converter 291 may receive a second sampling video sv2. The frame rate converter 291 may convert a frame rate in the second sampling video sv2 to output a third sampling video sv3. A processing operation corresponding to the frame rate converter 291 may be a frame rate conversion operation. The frame rate conversion operation may denote an operation of changing a frame rate to a frame rate capable of being displayed on a display (for example, the display device 230 of FIG. 1). For example, the frame rate converter 291 may change a frame rate or frequency of the second sampling video sv2 from about 60 Hz to about 120 Hz to output the third sampling video sv3.

The pre-processor 292 may receive the third sampling video sv3. The pre-processor 292 may perform a pre-processing operation on the third sampling video sv3 to output a fourth sampling video sv4. A processing operation corresponding to the pre-processor 292 may be a pre-processing operation. The pre-processing operation may denote an operation of correcting a color of a video. In detail, the pre-processing operation may include gamma value correction, contrast adjustment, and white balance adjustment.

The image quality processor 280 may receive the fourth sampling video sv4. The image quality processor 280 may perform an image quality processing operation on the fourth sampling video sv4 to output a final sampling video lsv.

The processor 210 may receive a sampling video from at least one of the video processors. The processor 210 may receive a sampling video from at least one of the input module 260, the scaler 270, the frame rate converter 291, the pre-processor 292, and the image quality processor 280. The processor 210 may determine whether an error has occurred in at least one of an input device and the video processors, based on an output order of each of a plurality of frames of the received sampling video and whether the sampling video is output normally or not.

In an embodiment, the processor 210 may receive a sampling video from each of the video processors and may determine whether at least one of an output order error and an abnormal output of each sampling video has occurred. The processor 210 may receive the third sampling video sv3 from the frame rate converter 291 and may determine whether at least one of an output order error and an abnormal output of the third sampling video sv3 has occurred. The processor 210 may determine whether at least one of an output order error and an abnormal output of the fourth sampling video sv4 from the pre-processor 292 has occurred. The processor 210 may first receive the final sampling video lsv.

When at least one of an output order error and an abnormal output of the third sampling video sv3 occurs, the processor 210 may determine that an error occurs in at least one of the input device and the electronic device 200. The processor 210 may determine whether an error of the frame rate converter 291 has occurred, based on whether an error of the scaler 270 has occurred. When at least one of an output order error and an abnormal output of the third sampling video sv3 occurs and an output order error and an abnormal output of the second sampling video sv2 do not occur, the processor 210 may determine that an error has occurred in the frame rate converter 291.

The processor 210 may determine whether an error of the pre-processor 292 has occurred, based on whether an error of the frame rate converter 291 has occurred. When at least one of an output order error and an abnormal output of the fourth sampling video sv4 occurs and an output order error and an abnormal output of the third sampling video sv3 do not occur, the processor 210 may determine that an error has occurred in the pre-processor 292.

The processor 210 may determine whether an error of the image quality processor 280 has occurred, based on whether an error of the pre-processor 292 has occurred. When at least one of an output order error and an abnormal output of the final sampling video lsv occurs and an output order error and an abnormal output of the fourth sampling video sv4 do not occur, the processor 210 may determine that an error has occurred in the image quality processor 280.

FIG. 7A is a diagram for describing a case where an output order error does not occur, according to an embodiment.

Referring to FIG. 7A, it may be assumed that a video vd includes a first frame (frame 0), a second frame (frame 1), and a third frame (frame 2). The video vd may be a test video, or may be a sampling video. Each of a plurality of frames may include a first pattern. The first frame (frame 0) may include a first pattern p1_1, the second frame (frame 1) may include a first pattern p1_2, and the third frame (frame 2) may include a first pattern p1_3.

The first frame (frame 0), the second frame (frame 1), and the third frame (frame 2) of the video vd may be sequentially input to the processor 210. The processor 210 may decode the first patterns p1_1, p1_2, and p1_3 to determine an output order of a frame corresponding to the first patterns p1_1, p1_2, and p1_3. For example, the processor 210 may decode the first pattern p1_1 to determine that an output order of the first frame (frame 0) is No.1. The processor 210 may decode the first pattern p1_2 to determine that an output order of the second frame (frame 1) is No.2. The processor 210 may decode the first pattern p1_3 to determine that an output order of the third frame (frame 2) is No.3.

In an embodiment, when an output order corresponding to a current frame is sequential to an output order corresponding to a previous frame, the processor 210 may determine that an output order error does not occur. When a current frame is the second frame (frame 1), No.2 which is an output order corresponding to the second frame (frame 1) may be sequential to No.1 which is an output order corresponding to the first frame (frame 0), and thus, the processor 210 may determine that an output order error does not occur. When a current frame is the third frame (frame 2), No.3 which is an output order corresponding to the third frame (frame 2) may be sequential to No.2 which is an output order corresponding to the second frame (frame 1), and thus, the processor 210 may determine that an output order error does not occur. For example, when the video vd is a first sampling video, the processor 210 may determine that an output order error of the first sampling video does not occur.

FIG. 7B is a diagram for describing a case where an output order error occurs, according to an embodiment.

The first frame (frame 0), the second frame (frame 1), and the third frame (frame 2) of the video vd may be sequentially input to the processor 210. The processor 210 may decode the first patterns p1_1, p1_2, and p1_3 to determine an output order of a frame corresponding to the first patterns p1_1, p1_2, and p1_3. For example, the processor 210 may decode the first pattern p1_1 to determine that an output order of the first frame (frame 0) is No.1. The processor 210 may decode the first pattern p1_2 to determine that an output order of the second frame (frame 1) is No.2. The processor 210 may decode the first pattern p1_3 to determine that an output order of the third frame (frame 2) is No.6. For example, in FIG. 7B, the first pattern p1_3 including bands of a first color at positions 1-4 and 6 and bands of a second color at positions 5 and 7 may indicate order No.6. Since pattern p1_3 indicates order No.6 and occurs adjacently after pattern p1_2 having order No. 2, and No. 6 and No.2 are not sequential to one another, an output order error has occurred.

In an embodiment, when an output order corresponding to a current frame is not sequential to an output order corresponding to a previous frame, the processor 210 may determine that an output order error has occurred. When a current frame is the third frame (frame 2), No.6 which is an output order corresponding to the third frame (frame 2) is not sequential to No.2 which is an output order corresponding to the second frame (frame 1), and thus, the processor 210 may determine that an output order error has occurred. For example, when the video vd is a first sampling video, the processor 210 may determine that an output order error of the first sampling video has occurred. For example, when the output order error of the first sampling video occurs, the processor 210 may determine that an error has occurred in the input device.

FIG. 8A is a diagram for describing a second pattern according to an embodiment.

A processor may compare a predetermined pixel value with a pixel value of a pixel of a predetermined position among pixels of a second pattern representing a plurality of colors and may determine whether a sampling video sv is output normally or not, based on the comparison. The pixel of the predetermined position may be pixels implementing each of a plurality of colors of a second pattern p2. The number of pixels of the predetermined position of each of the plurality of colors among the pixels implementing each of the plurality of colors of the second pattern p2 may be one. For example, a pixel of a predetermined position among pixels implementing a blue color may be a first pixel pxa. A pixel of a predetermined position among pixels implementing a green color may be a second pixel pxb. A pixel of a predetermined position among pixels implementing a red color may be a third pixel pxc.

The processor may compare a predetermined pixel value with a pixel value of a predetermined position of a sampling video sv. The processor may compare a predetermined pixel value with a pixel value of each of a first pixel pxa, a second pixel pxb, a third pixel pxc, a fourth pixel pxd, a fifth pixel pxe, a sixth pixel pxf, and a seventh pixel pxg of a predetermined position.

When the predetermined pixel value is the same as the pixel value of the predetermined position of the sampling video sv, the processor may determine that a normal output of the sampling video sv has occurred. For example, when the pixel value of each of the first to seventh pixels pxa to pxg matches a predetermined pixel value corresponding to each of the first to seventh pixels pxa to pxg, the processor may determine that a normal output of the sampling video sv has occurred. For example, if the color of a pixel in a band of the second pattern p2 is expected to be a first color, but ends up being a color other than the first color (i.e., a second-seventh color), it can be concluded that a normal output has not occurred.

When the predetermined pixel value is not equal to the pixel value of the predetermined position of the sampling video sv, the processor may determine that an abnormal output of the sampling video sv has occurred. For example, when the pixel value of at least one of the first to seventh pixels pxa to pxg does not match at least one of the predetermined pixel values respectively corresponding to the first to seventh pixels pxa to pxg, the processor may determine that an abnormal output of the sampling video sv has occurred. For example, when the sampling video sv is a first sampling video, the processor 210 may determine that an abnormal output of the first sampling video has occurred. Because the abnormal output of the first sampling video occurs, the processor 210 may determine that an error has occurred in the input device.

When the pixel value of the predetermined position of the sampling video sv is within a predetermined pixel value range, the processor may determine that a normal output of the sampling video sv has occurred. When the pixel value of the predetermined position of the sampling video sv is outside the predetermined pixel value range, the processor may determine that an abnormal output of the sampling video sv has occurred. For example, if the color wavelength of a pixel in a band of the second pattern p2 is expected to be within a color wavelength range, but ends up being outside the color wavelength range, it can be concluded that a normal output has not occurred.

FIG. 8B is a diagram for describing a second pattern according to an embodiment. Descriptions which are the same as or similar to the above descriptions are omitted.

Referring to FIG. 8B, the number of pixels of a predetermined position of each of a plurality of colors among pixels implementing each of the plurality of colors of a second pattern p2 may be in plurality. For example, a pixel of a predetermined position among pixels implementing a blue color may be a first pixel pxa1, a first pixel pxa2, and a first pixel pxa3. A pixel of a predetermined position among pixels implementing a yellow color may be a fourth pixel pxd1 and a fourth pixel pxd2.

The processor may compare a predetermined pixel value with a pixel value of a predetermined position of a sampling video sv. For example, the processor may compare a predetermined pixel value with a pixel value of each of the first pixel pxa1, the first pixel pxa2, and the first pixel pxa3.

When the pixel value of each of the first pixel pxa1, the first pixel pxa2, and the first pixel pxa3 matches a predetermined pixel value corresponding to each of the first pixel pxa1, the first pixel pxa2, and the first pixel pxa3, the processor may determine that a normal output on a blue color has occurred. Referring back to FIG. 8A, when a pixel value of each of first to seventh pixels pxa to pxg matches a predetermined pixel value corresponding to each of the first to seventh pixels pxa to pxg, the processor may determine that a normal output has occurred. Because pixel values of pixels of a plurality of pixel positions on one color are compared with one another, whether the sampling video sv is output normally or not may be accurately determined.

In FIG. 8B, when the pixel value of each of the first pixel pxa1, the first pixel pxa2, and the first pixel pxa3 does not match at least one of the predetermined pixel values respectively corresponding to the first pixel pxa1, the first pixel pxa2, and the first pixel pxa3, the processor may determine that an abnormal output on a blue color occurs and may determine that an abnormal output of the sampling video sv occurs.

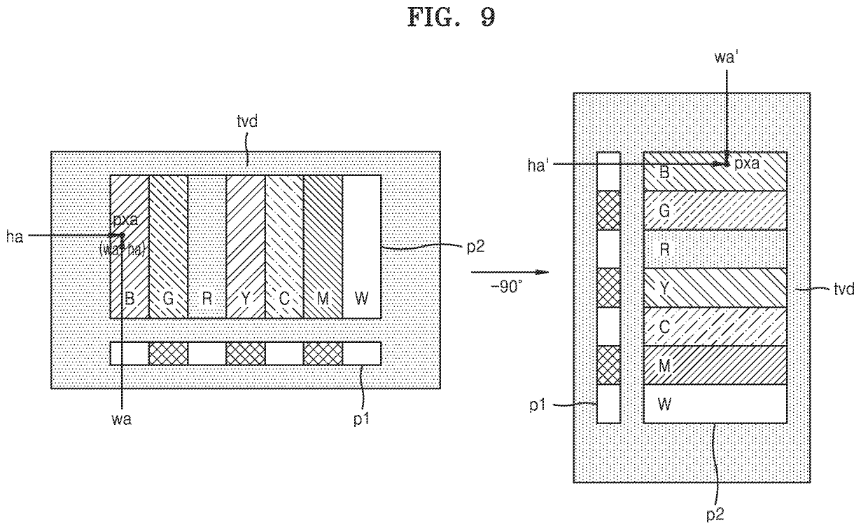

FIG. 9 is a diagram for describing a case where a test video tvd has been rotated, according to an embodiment.

Referring to FIG. 9, the test video tvd is rotated. For example, the test video tvd may rotate by about 90 degrees in a counterclockwise direction. When the test video tvd has rotated by about 90 degrees in the counterclockwise direction, an angle by which the test video tvd has rotated may be about −90 degrees. A processor (for example, the processor 210 of FIG. 1) may determine whether the test video tvd has rotated.

When the test video tvd has rotated, the processor may determine an output order of each of a plurality of frames of a sampling video and whether the sampling video is output normally or not, based on at least one pattern and an angle by which the test video tvd has rotated. When the test video tvd has rotated, the processor may calculate positions of pixels configuring the test video tvd, based on a rotated angle.

When the test video tvd has rotated, the processor may newly calculate a predetermined position by reflecting the rotated angle, so as to determine an output order error of the sampling video and whether the sampling video is output normally or not. The processor may change the predetermined position to a rotation position, based on the rotated angle. For example, when the test video tvd has rotated by about −90 degrees, the processor may change a predetermined position (wa, ha) to a rotation position (wa′, ha′).

The processor may compare a predetermined pixel value with a pixel value of a pixel which is at a rotation position calculated by reflecting a rotated angle in a sampling video and may determine whether the sampling video is output normally or not, based on a comparison result. For example, the processor may compare the predetermined pixel value with a pixel value of the first pixel pxa which is at the rotation position (wa′, ha′).

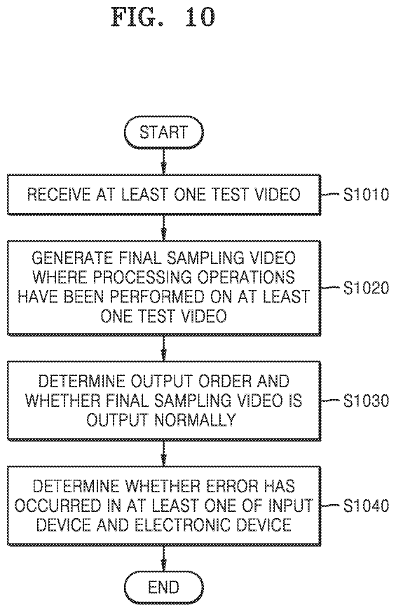

FIG. 10 is a flowchart for describing an operating method of an electronic device, according to an embodiment.

In operation S1010, the electronic device receives at least one test video. The electronic device may receive the at least one test video from an input device. For example, the electronic device may be the sink device 200, and the input device may be the source device 100. Each of the at least one test videos may include a plurality of frames, and each of the plurality of frames may include at least one pattern.

In an embodiment, each of a plurality of frames of the test video may include a first pattern and a second pattern. The first pattern may indicate an output order of each of the plurality of frames. For example, when one test video includes three frames, a first frame may include a first pattern corresponding to No.1 output order, a second frame may include a first pattern corresponding to No.2 output order, and a third frame may include a first pattern corresponding to No.3 output order. The second pattern may represent a plurality of colors. For example, the second pattern may be a pattern including a red color, a blue color, and a green color. However, the inventive concept is not limited thereto, and the second pattern may include various colors.

The electronic device may process and play a test video transmitted from the input device. The electronic device may perform processing operations for playing a video. The processing operation may denote an operation of processing a video to display the video on a display. For example, the processing operation may include a standardization operation, a decoding operation, a scaling operation, color correction, a frame rate changing operation, and an image quality processing operation. However, the inventive concept is not limited to listed examples.

The electronic device may perform each of processing operations on a test video to generate a sampling video. Each of a plurality of frames of the sampling video may include at least one pattern. For example, the electronic device may perform a standardization operation on the test video to generate a first sampling video. The electronic device may perform a scaling operation on the first sampling video and may generate a second sampling video.

In operation S1020, the electronic device generates a final sampling video where a plurality of processing operations are performed on the at least one test video. The final sampling video may denote a sampling video which is generated after the processing operations are performed on the test video. For example, in a processing operation where an image quality processing operation is performed last, a sampling video on which the image quality processing operation has been performed may be the final sampling video.

In operation S1030, the electronic device determines an output order of the final sampling video and whether the final sampling video is output normally or not, based on the at least one pattern. In an embodiment, the electronic device determines an output order of each of a plurality of frames included in the final sampling video, based on a first pattern. The electronic device may determine an output order of the final sampling video and may determine whether an output order error has occurred based on the determined output order. When an output order corresponding to a current frame of the final sampling video is sequential to an output order corresponding to a previous frame, the electronic device may determine that an output order error does not occur. For example, when a current frame is a second frame, No.2 which is an output order corresponding to the second frame may be sequential to No.1 which is an output order corresponding to a first frame which is a previous frame, and thus, the electronic device may determine that an output order error does not occur.

When the output order corresponding to the current frame of the final sampling video is not sequential to the output order corresponding to the previous frame, the electronic device may determine that an output order error has occurred. For example, when a current frame has a first pattern indicating a No.6 order and the current frame is sequential to a frame having a first pattern indicating a No.2 order, the electronic device may determine that an output order error has occurred.

In an embodiment, the electronic device may determine whether the final sampling video is output normally or not, based on the second pattern. The electronic device may compare a predetermined pixel value with a pixel value of a pixel of a predetermined position among pixels implementing the second pattern representing a plurality of colors and may determine whether the final sampling video is output normally, based on the comparison. The pixel of the predetermined position may be pixels implementing each of a plurality of colors of the second pattern.

When the predetermined pixel value is the same as the pixel value of the predetermined position of the final sampling video, the electronic device may determine that a normal output of the final sampling video occurs. For example, when a pixel value of each of first to seventh pixels matches predetermined pixel values respectively corresponding to the first to seventh pixels, the electronic device may determine that a normal output occurs.

When the predetermined pixel value is not equal to the pixel value of the predetermined position of the final sampling video, the electronic device may determine that an abnormal output of the final sampling video occurs. For example, when the pixel value of each of the first to seventh pixels does not match at least one of the predetermined pixel values respectively corresponding to the first to seventh pixels, the electronic device may determine that an abnormal output of the final sampling video occurs.

When the pixel value of the predetermined position of the final sampling video is within a predetermined pixel value range, the electronic device may determine that a normal output of the final sampling video occurs. When the pixel value of the predetermined position of the final sampling video is outside the predetermined pixel value range, the electronic device may determine that an abnormal output of the final sampling video occurs.

In operation S1040, the electronic device determines whether an error occurs in at least one of an input device and the electronic device, based on an output order of each of a plurality of frames of the final sampling video and whether the final sampling video is output normally. When an output order error and an abnormal output of the final sampling video do not occur, the electronic device may determine that an error does not occur in the input device and the electronic device.

When at least one of an output order error and an abnormal output of the final sampling video occurs, the electronic device may determine that an error occurs in at least one of the input device and the electronic device. The electronic device may determine whether an error occurs in at least one of the input device and the electronic device, based on whether at least one of an output order error and an abnormal output of a sampling video generated prior to the final sampling video occurs. The determining of the output order error and the abnormal output of the sampling video generated prior to the final sampling video may be performed by a method which is similar or equal to a method of determining the output order error and the abnormal output of the final sampling video described above.

Hereinabove, embodiments have been described in the drawings and the specification. Embodiments have been described by using the terms described herein, but this has been merely used for describing the inventive concept and has not been used for limiting a meaning or limiting the scope of the inventive concept defined in the following claims. Therefore, it may be understood by those of ordinary skill in the art that various modifications and other equivalent embodiments may be implemented from the inventive concept.

While the inventive concept has been particularly shown and described with reference to embodiments thereof, it will be understood that various changes in form and details may be made therein without departing from the spirit and scope of the following claims.

1. An electronic device for processing and playing a video transmitted from an input device, the electronic device comprising:
a plurality of video processors configured to perform processing operations based on a test video including a plurality of frames received from the input device to generate a sampling video including the plurality of frames, where each of the frames includes at least one pattern; and
a processor configured to receive the sampling video,
wherein the processor is configured to determine an output order of each of the plurality of frames of the sampling video and whether the sampling video is output normally or not, based on the at least one pattern, and
wherein the processor is further configured to determine whether an error has occurred in at least one of the input device and the plurality of video processors, based on the output order of each of the plurality of frames and whether the sampling video is output normally or not.

2. The electronic device of claim 1, wherein the processor is configured to
check an output order of a current frame among the frames, based on a first pattern of the at least one pattern indicating the output order of each of the plurality of frames, and
when the output order corresponding to the current frame is not sequential to an output order corresponding to a previous frame, determine that an output order error has occurred.

3. The electronic device of claim 2, wherein the first pattern comprises a binary pattern.

4. The electronic device of claim 1, wherein the processor is configured to compare a predetermined pixel value with a pixel value of a pixel of a predetermined position among pixels implementing a second pattern representing a plurality of colors and determine whether the sampling video is output normally or not, based on the comparison.

5. The electronic device of claim 4, wherein the at least one pattern comprises the second pattern,
wherein the second pattern included in each of the plurality of frames is the same.

6. The electronic device of claim 1, wherein each of the plurality of video processors comprises an input module configured to standardize the test video to generate a first sampling video, and
the processor is configured to receive the first sampling video from the input module and, when at least one of an output order error of the first sampling video and an abnormal output of the first sampling video occurs, determine that an error occurs in the input device.

7. The electronic device of claim 1, wherein the processor is configured to
receive the sampling video from each of the plurality of video processors and determine whether at least one of an output order error and an abnormal output of each of the sampling videos occurs, and
determine whether an error occurs in a target video processor among the video processors, based on whether an error has occurred in one of the video processors which performs the processing operation on the test video prior to the target video processor outputting a sampling video where at least one of the output order error and the abnormal output has occurred.

8. The electronic device of claim 1, wherein the processor is configured to
receive a final sampling video from a final video processor among the video processors that performs the processing operation last among the plurality of video processors and
determine whether an error has occurred in at least one of the input device and the plurality of video processors, based on an output order of each of a plurality of frames of the final sampling video and whether the final sampling video is output normally or not.

9. The electronic device of claim 8, wherein the processor is configured to, when an output order error of each of a plurality of frames of the final sampling video does not occur and a normal output of the final sampling video has occurred, determine that no error has occurred in the input device and the plurality of video processors.

10. The electronic device of claim 8, wherein the processor is configured to, when at least one of an output order error and an abnormal output of the final sampling video has occurred, determine whether an error has occurred in at least one of the input device and the plurality of video processors, based on whether an error has occurred in a video processor among the video processors which performs the processing operation on the test video prior to the final video processor.

11. The electronic device of claim 1, wherein the processor is configured to determine whether the test video is rotated or not, and when the test video is rotated, determine an output order of each of the plurality of frames on the sampling video and whether the sampling video is output normally or not, based on the at least one pattern and an angle by which the test video is rotated.

12. The electronic device of claim 1, further comprising a display panel configured to display the video,
wherein the processor is configured to, when an error occurs in at least one of the input device and the plurality of video processors, control the display panel to display a notification indicating that the error occurs.

13. An electronic device for processing and playing a video transmitted from an input device, the electronic device comprising:
an input module configured to receive at least one test video from the input device, each test video including a plurality of frames including a first pattern and a second pattern; and
a processor configured to check an output order of each of the plurality of frames included in at least one sampling video generated from performing a processing operation on the at least one test video, based on the first pattern, check whether the at least one sampling video is output normally, based on the second pattern, and
determine whether an error occurs in at least one of the input device and the electronic device, based on the output order and whether the at least one sampling video is output normally.

14. The electronic device of claim 13, wherein the processor is configured to receive a first sampling video of the at least one sampling video from the input module, where the at least one test video is standardized to generate the first sampling video, and determine that an error occurs in the input device when at least one of an output order error of the first sampling video and an abnormal output of the first sampling video occurs.

15. The electronic device of claim 14, further comprising a scaler configured to perform a scaling operation on the first sampling video to generate a second sampling video,
wherein the processor is configured to determine that an error occurs in at least one of the input device and the scaler, when at least one of an output order error and an abnormal output of the second sampling video received from the scaler occurs.

16. The electronic device of claim 15, wherein the processor is configured to determine that an error occurs in the scaler, when at least one of the output order error and the abnormal output of the second sampling video occurs and the output order error and the abnormal output of the first sampling video do not occur.

17. The electronic device of claim 15, further comprising an image quality processor configured to perform an image quality processing operation on the second sampling video to generate a final sampling video,
wherein the processor is configured to determine that an error occurs in at least one of the input device, the scaler, and the image quality processor, when at least one of an output order error and an abnormal output of the final sampling video received from the image quality processor occurs.

18. The electronic device of claim 17, wherein the processor is configured to determine that an error occurs in the image quality processor when at least one of the output order error and the abnormal output of the final sampling video occurs and the output order error and the abnormal output of the second sampling video do not occur.

19. The electronic device of claim 13, wherein the at least one test video includes a plurality of test videos having different resolutions.

20. An electronic device for processing and playing a video transmitted from an input device, the electronic device comprising:
an input module configured to receive at least one test video from the input device, each test video including a plurality of frames including a first pattern and a second pattern;
a processor configured to check an output order of each of a plurality of frames included in at least one sampling video generated from performing a processing operation on the at least one test video, based on the first pattern, check whether the at least one sampling video is output normally, based on the second pattern, and determine whether an error occurs in at least one of the input device and the electronic device, based on the output order and whether the at least one sampling video is output normally; and
a display device configured to display information indicating a location of the error, when the error occurs in at least one of the input device and the electronic device.

21-24. (canceled)
